(19) United States
(12) Patent Application Publication
(10) Pub. No.: US 2014/0173554 A1
(43) Pub. Date: Jun. 19, 2014

(54) Platform and a method for development of a software application

(71) Applicant: ARUNAV GUPTA, BANGALORE (IN)

(72) Inventor: ARUNAV GUPTA, BANGALORE (IN)

(21) Appl. No.: 14/187,494

(22) Filed: Feb. 24, 2014

(51) Int. Cl. G06F 9/44

(52) U.S. Cl. CPC G06F 8/20; G06F 8/30
USPC 717/106; 717/100

(57) ABSTRACT

A platform for development of a software application having a distributed computing environment including a plurality of server computers with software providing storage and hosting capabilities, a set of structural building blocks including entity, relation, action for defining data structures, a set of security building blocks including user, user permission, profile for defining security settings, a set of layout building blocks including site, view, form for defining a user interface design for the software application and a module to configure and assemble the sets of the structural, the security and the layout building blocks as the software application. The present invention further provides a method of using the platform of the present invention for developing a software application.

### FIELD OF THE INVENTION

The present invention relates generally to application development platform and, more particularly to an integrated platform-as-a-service and a method that enables users to build, run and manage software applications.

### BACKGROUND OF THE INVENTION

A ‘computing platform’ in general means a pre-existing environment for a piece of software designed to run within it, obeying its constraints, and making use of its facilities. Typical platforms include hardware architecture, an operating system (OS) and runtime libraries. The computing platform generally includes the operating system and computer hardware only. The platform conforms to a set of standards that enable software developers to develop software applications for the platform. These same standards allow owners and managers to purchase appropriate applications and hardware.

New standards-based interfaces and open interfaces allow applications programs to run on multiple platforms. Additionally, software developers have developed software tools that allow applications to run on multiple platforms. This has given rise to the terms cross-platform software and multi-platform software.

An example of a computing platform is a modern laptop running Windows as an operating system. Other examples of computing platform are mobile device with Android OS, Or Server Computers with Linux OS and Apache Web Server.

Cloud computing, often referred to as simply ‘the cloud’, is the delivery of on-demand computing resources everything from applications to data centres over the Internet on a pay-for-use basis. Services made available to users on demand via the Internet from a cloud computing provider's servers as opposed to being provided from a company's own on-premises servers. Cloud services are designed to provide easy, scalable access to applications, resources and services, and are fully managed by a cloud services provider.

A cloud service can dynamically scale to meet the needs of its users, and because the service provider supplies the hardware and software necessary for the service, there's no need for a company to provision or deploy its own resources or allocate IT staff to manage the service.

The major models of cloud computing service are known as ‘software as a service’, ‘platform as a service’, and ‘infrastructure as a service’. Software as a service (SaaS) is a model of software deployment in which a user accesses and uses a piece of software from a remote location. Instead of purchasing a license to operate the software on a local machine, a user may be charged by usage of the software which is available over the cloud computing system. SaaS runs on remote computers “in the cloud” that are owned and operated by others and that connect to users' computers via the Internet and, usually, a web browser.

‘Infrastructure as a service’ provides companies with computing resources including servers, networking, storage, and data center space on a pay-per-use basis. ‘Platform as a service’ (PaaS) provides a cloud-based environment with everything required to support the complete life cycle of building and delivering web-based (cloud) applications without the cost and complexity of buying and managing the underlying hardware, software, provisioning and hosting. A typical PaaS offering includes a computing platform and a set of solutions made available as a service. Such a service allows developing software using tools and libraries from the platform provider. The provider provides the core hardware namely networks, servers, storage and other services along with underlying software that includes hosting capabilities.

PaaS offerings facilitate the deployment of applications without the cost and complexity of buying and managing the underlying hardware and software and provisioning hosting capabilities. There are various types of PaaS vendors all offering application hosting and a deployment environment, along with various integrated services. Services offer varying levels of scalability and maintenance. PaaS offerings may also include facilities for application design, application development, testing, and deployment as well as services such as team collaboration, web service integration, and marshalling, database integration, security, scalability, storage, persistence, state management, application versioning, application instrumentation, and developer community facilitation.

There are other known platforms for developing software available in prior art which are also provided as service, however they still require programming to be done during the development of software. A majority of such programming involves developing base framework providing standard database operations, application programming interfaces and user interfaces. This causes disadvantages of complexities, time and cost on development activities that are redundant across cloud based projects. Further such platforms also have limitations like vendor lock-in-where the ability to migrate application from one platform to another is limited and may even require rewriting the application, the platform runtimes are optimized for a specific set of languages and frameworks (for example Google App Engine only supports Python, Java and Go), limitations on integration with other systems; data security configurability, etc.

In view of the disadvantages inherent in the available platforms for software development, there exists need for an improved platform and method for developing software application which is an inexpensive, reusable, compact and capable of overcoming disadvantages inherent in above mentioned platforms in a cost effective, secure, and environmental friendly manner. The present invention fulfils this need and provides further advantages as described in the following summary.

### SUMMARY OF THE INVENTION

In view of the foregoing disadvantages inherent in the prior arts, the general purpose of the present invention is to provide an improved combination of convenience and utility, to include the advantages of the prior art, and to overcome the drawbacks inherent therein.

A primary objective of the present invention is to provide a platform and method of software application development having advantages not taught by the prior art.

In one aspect, the present invention provides a platform for development of a software application which comprises a distributed computing environment including server computer with a software having storage and hosting capabilities, a set of structural building blocks including entity, relation, action for defining data structures of the software application, a set of security building blocks including user, user permission, profile for defining security settings for the software application, a set of layout building blocks including site, view, form for defining the user interface design for the software application and a module to configure and assemble the sets of the structural, the security and the layout building blocks as the software application.

In another aspect of the present invention the software application deployed on a computing device interacts with the platform to use the distributed computing environment.

In another aspect of the present invention the platform further comprises an Application Programming Interface (API) allowing integration of the software application running on the platform with an external software system through standard web communication protocols.

In yet another aspect of the present invention the configuring and assembling of the sets of the structural, the security and the layout building blocks automatically writes a required source code for the software application.

In another aspect the present invention the platform automatically writes a required source code for running the software application on a mobile computing device.

In another aspect the present invention the platform is offered as a service for the development of the software application.

In yet another aspect, the present invention provides a method of developing a software application using the platform of the present invention.

These together with other aspects of the invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the invention.

### BRIEF DESCRIPTION OF THE DRAWINGS

The advantages and features of the present invention will become better understood with reference to the following more detailed description taken in conjunction with the accompanying drawings in which:

FIG. 1 illustrates a schematic diagram of a platform for software application development, according to one embodiment of the present invention;

FIG. 2 illustrates a schematic diagram depicting how the permissions on entities propagate to users, according to one embodiment of the present invention; and

FIG. 3 illustrates a flowchart of the method of developing software application using the platform of the present invention, according to one embodiment of the present invention.

Like reference numerals refer to like parts throughout the several views of the drawings.

### DETAILED DESCRIPTION OF THE DRAWINGS

In the following description, for purposes of explanation, numerous specific details are set forth in order to provide a thorough understanding of the present invention. It will be apparent, however, to one skilled in the art that the present invention may be practiced without these specific details.

As used herein, the term ‘plurality’ refers to the presence of more than one of the referenced item and the terms ‘a’, ‘an’, and ‘at least’ do not denote a limitation of quantity, but rather denote the presence of at least one of the referenced item.

The terms ‘software solution’ or ‘software application’ may be used herein interchangeably and refer to convey the same meaning.

The trademarks, website names, programming language names etc used in the present description are property of the respective owner companies and used herein for illustrative purposes only. The inventor does not claim any rights on it.

In an exemplary embodiment, the present invention provides a platform and method for development of a software application. The platform and method of the present invention may be used for mass implementation and reproduction in an easy, cost effective, environment friendly and productive way.

It is to be understood that the improvements of the present invention are applicable to any of a number of platform and method for development of a software application, other than those which are specifically described below. Such methods and devices will be readily understood by the person of ordinary skill in the art, and are achievable by causing various changes that are themselves known in state of the art.

Reference herein to “one embodiment” or “another embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of steps in process flowcharts or diagrams representing one or more embodiments of the invention do not inherently indicate any particular order nor imply any limitations in the invention.

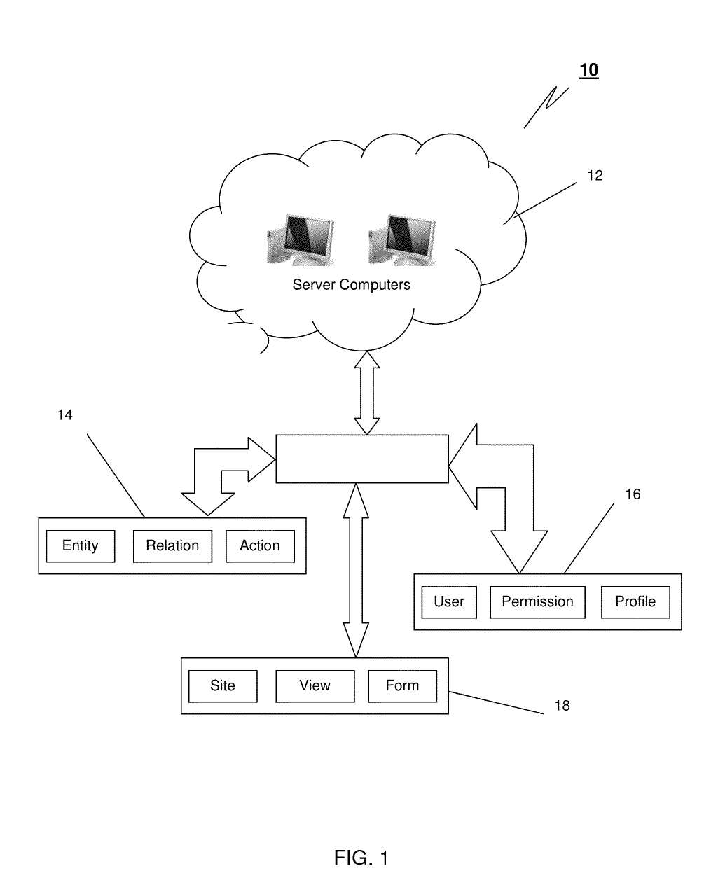

Referring to FIG. 1 that illustrates a schematic diagram of a platform 10 for development of a software application. The platform comprises a distributed computing environment 12 including a plurality of server computers with a software providing storage and hosting capabilities, a set of structural building blocks 14 including entity, relation, action for defining data structures of the software application, a set of security building blocks 16 including user, user permission, profile for defining security settings for the software application, a set of layout building blocks 18 including site, view, form for defining a user interface design for the software application and a means 20 to configure and assemble the sets of the structural, the security and the layout building blocks as the software application.

A software solution represents a consolidated package of entities, relations and actions along with user interface and security information relevant to the package. As such solution allows grouping of components relevant to solution functionality, they may be deployed or removed as a single package and is portable across different domains.

The distributed computing environment 12 is the infrastructure in the cloud which provides all hardware resources in the form of plurality of server computers for storing the files of the software application. The computing environment 12 also has software which allows a software application developer to upload files and run the software application using the resources of the distributed network 12. The platform 10 provides each consumer a dedicated instance of the platform service with dedicated storage space. Such an instance of platform service is called a ‘domain’. And each of these domains can have different combination of solutions deployed and running on them to address specific consumer's needs.

The distributed network 12 may offer additional resources such as a virtual-machine disk image library, block and file-based storage, firewalls, load balancers, IP addresses, virtual local area networks (and software bundles. These resources are provided on-demand to a user from the large pools of servers in the distributed network 12.

The primary building blocks of the platform 10 are entities, relations and actions. These building blocks can be assembled together with Security 16 and layout blocks 18 elements relevant to the solution using the means 20 to configure and assemble and grouped into a single package to create software solution.

The set of structural building blocks 14 are a group of entities that define the data model of the software solution. Basically it allows configuring the different tables (columns) of the data structure and their relationships with other tables. The set includes entity, relation, and action for defining data structures of the software application. In one embodiment the set of structural building block 14 contains:

This set structural building block 14 contains:—
Entity (Type)—to specify name for a database table in which different records will be stored
Attribute—the different types of columns associated with the entity
Relations—to relate two different entities as one to one, one to many or many to many
Actions—operations associated with the entities like creating, updating, deleting records etc
Option Sets—for select drop down type attributes the different options available in them
Web Folders—a hierarchical folder structure into which different files can be uploaded
Emails—to send or receive emails from and to the Eras system
Solutions—To group the different entities, relations, etc. such that they can be exported as a configuration package.

Each entity has actions associated with it and the entities can be related to each other using relations. Besides entity specific actions there may also be actions that are common to all entities. An entity is analogous to a class in programming terms or a table in database terms. Although entities of the platform 10 do possess a strong resemblance with database tables by creating a data store for persisting records of the given entity type, but there are a few differences. The implicit behaviors of an entity are actions associated with the entity that gets auto triggered when a record of the given entity is created, updated, deleted or any other action is performed on it. While explicit behaviors are actions that can be initiated by users. Such implicit and explicit behaviors are called ‘On Event’ and ‘On Demand’ Actions in the platform 10. There may be a third kind of action known as ‘on schedule’ actions that are triggered by the time dimension.

Besides defining the metadata about the data structure for storing records of an entity, the entity also contains basic rendering information about how the entity is displayed in standard views and forms. Further, user interface information of an entity is extensible and customizable. Entities of platform 10 also includes field validation by allowing the user to define constraints like uniqueness when required, by providing an assortment of attribute validation options that covers almost every possible business rule.

Attributes are properties of an entity that define its structure, for this a set of different attributes are associated with each entity record. Although names of attribute form fields are self-explanatory but there are a few that requires elaboration.

The Attribute Type denotes the type of attribute being created, the possible types are:
1) Single Line: to store single line of text.
2) Multiple Lines: to store multiple lines of text.
3) Date Time: to store date, time or combined date-time value.
4) Two Option: (true/false) value
5) Whole Number: to store integer value.
6) Floating Number: to store float value.
7) Decimal Number: to store floating value with higher degree of precision while computing.
8) Currency: to store monetary value, with precision similar to decimal number but with added features.
9) Option Set: for selection dropdown to choose an option.
10) Lookup: for related entity's record unique identifier.

A relation is used to define relation between two entities to allow relating records of these entities. The relation can be of three types—
1) One to Many: in this relation the To Entity representing ‘Many’ should have a lookup attribute that should be specified in to attribute
2) One to One: in this relation both entities should have a Lookup attribute each specified in From and To attributes
3) Many to Many: in this relation neither entities need to have Lookup type attribute, rather a NtoN relation entity should be specified (an entity with no attribute), for such entity relation attributes will be automatically created by the name FromRecordId and ToRecordId, hence the NtoN relationship between records of the participating two entities is maintained in this third entity.

For creating a relation between two entities for example: ‘My Contact’ entity has a lookup attribute called ‘Current Company’ that stores a reference to a My Company entity record. A One-To-Many relationship should be created from My Company to My Contact entity. It is the My Contact entity that has lookup field, signifying a contact belongs to a specific company, while a company can have multiple contacts working for it, hence a One-To-Many relationship from My Company to My Contact. So precisely it should always be the entity at the ‘Many’ side that should have the lookup field in case of One-To-Many relation.

An action is any operation or behavior that changes the data in the system or performs dependent actions based on events that occur in the system. There are three types of Actions—
1) On Demand (triggered by user ex. Create Record, Update Record, etc.)
2) On Event (triggered by other Action or a sub action to an On Demand Action, ex. Create Table, Update Column, etc.)
3) On Schedule (triggered on configured time).

An action can be entity specific in which case the entity name (the system name of the entity) must be provided or it can be made available to all entities in which case the ‘Is For All Entities’ option should be selected.

The set of security building blocks 16 are a group of entities that define access permissions on each of the entity configured in the solution. This set of entities contain:—
Users—users who can log into the platform 10
Departments—to create a hierarchical organization structure and associated users with such business units
Filters—to create filter conditions corresponding to entities based on which access is granted to different user profiles
Permissions—to configure access for every action against each entity, such as create, read, update, and delete actions corresponding to an entity.
Profiles—to associate users with profiles (roles) that contain set of permissions based on which the corresponding user can perform action.

For example user ‘Raj’ can have a profile ‘Manager’ that has a set of permissions to create and read entity like ‘Contacts’.

The platform 10 has a robust multi-level security implementation which can be configured to permit or prohibit users from access to information and modification of information stored in the platform. Apart from security the platform 10 also provides capability of hiding certain information in order to simplify usage of the system through a feature called abstraction, however unlike security abstraction only applies at the presentation layer (such as hiding views and actions).

Security setup is done per entity by configuring a set of permissions corresponding to the entity and then grouping such permissions into profiles. Finally users are assigned these profiles which grants access to the user that is a union of all the permissions minus union of all restrictions applied to fields.

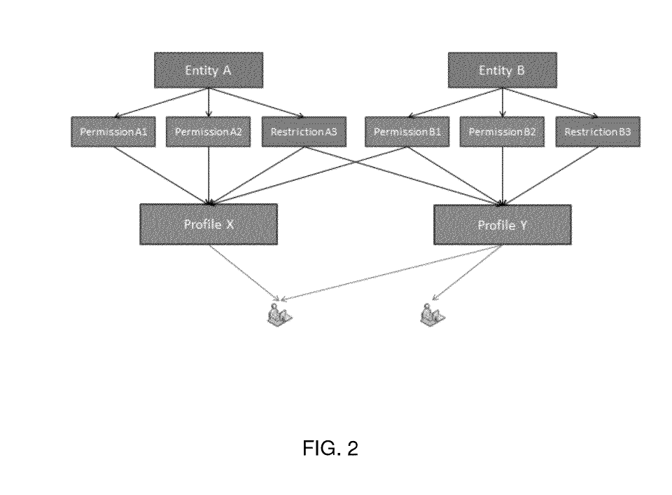

Referring to FIG. 2 that illustrates a schematic diagram depicting how the permissions on entities propagate to users, according to one embodiment of the present invention. Every record of permission corresponding to an entity specifies privileges on level of read, create, update and delete actions that can be performed on the entity. The possible levels are All, Filtered or None. For filtered privilege a subsequent security filter is specified. Such security filter limits the data of the entity that can be read or actions like create, update or delete can be performed on them. Besides CRUD (Read, Create, Update And Delete) operations permission also enables configuring other access like seeing related records, access on documents attached with such records, UI form and view abstraction, access to other actions possible on the entity records and field level restrictions like hiding specific fields, preventing create or update of specific fields.

Once such permission is configured for an entity it is assigned to a profile which in turn is assigned to a user. This allows user access based on the configured permission. Further such permission can also be assigned to the Guest Profile which grants the permission access to public user (without login identity).

Creating users and profiles require simple information, and then each user can be connected with profiles by selecting the corresponding relation in the prop view and creating corresponding relation record. Similarly profiles are connected with permissions.

The next component of platform 10 which is the set of layout building block 18 are a group of entities that define customizations to look and feel of each entity when they are being displayed to users. Corresponding to each entity configured in the system a set of views and forms are automatically created by the platform 10. However it is possible to configure more such views and forms or modify the ones created by default. The set of layout block 18 contains:—
Site—to configure the landing page with different links that appears to the user. It is possible to configure multiple sites, each for different set of users; for example internet visitors can be presented a read-only site that does not require sign-in. While customers and employees can have different site for each that require sign in.
Navigation Groups—to configure groups of links available in the site.
Forms—to configure the dialog through which users can add or edit records of each entity.
Views—to configure the grid (table) that shows records corresponding to each entity.
Form Scripts—to configure JavaScripts that add behaviours to the forms.
View Scripts—to configure JavaScripts that add behaviours to the views.
Reports—to configure different types of charts based on data present in the system.

The three primary layout block 18 objects namely sites, views and forms define how these objects will be rendered for the entities. There are certain internally defined User Interface (UI) objects that outline the default rendering, these include a MainSite that is available to each platform domain and is the default site for administration, however all users in the domain can sign into it but will get access based on their permissions. Further by default four internal views namely MainView, PropView, LookupView and SystemView, and internal form named MainForm is automatically created for each entity. Besides using internal views (MainView, LookupView, PropView and SystemView) a user may also create custom views configuring columns for the view with display formatting and data filter.

Similar to the entity's views, entity's forms can also be customized in two ways, either by adding custom JavaScripts to the default Main Form of the entity or creating new form for the entity. Besides using MainForm one can also create custom forms configuring the columns, formatting and data filter.

In one embodiment the software application is deployed to run in the platform 10 using the distributed computing environment 12. To deploy their applications, the users install operating-system images and their application software on the computing environment 12. The computing environment 12 maintains the operating systems and the software to allow the application to run on the platform 12. The platform providers may typically bill its services on a utility computing basis, cost reflects the amount of resources allocated and consumed.

In one embodiment the software application is downloaded from the platform to be deployed on a computing device. The software application can be developed using the platform and then it can be downloaded from the platform into a user device. In one embodiment the software application deployed on the user computing device interacts with the platform 10 to use the distributed computing environment 12.

In another embodiment the configuring and assembling of the sets of the structural, the security and the layout building blocks done by the module 20 automatically writes a required source code for the software application. In yet another embodiment the module 20, automatically writes a required source code for running the software application on a mobile computing device.

The platform 10 requires little or no programming source code to be written as the platform automatically generates data storage structures, graphical user interface (GUI) and application programming interface (API) along with data and content management actions that can be performed from GUI or API. The platform also provides security framework for defining access permissions on entities, relations and actions encapsulated in the solution.

Apart from eliminating the need of writing any source code for basic functionalities, the platform further automates solution development by auto generating source code such as mobile device app code corresponding to solution sites configured and running on the platform 10. The target programming language(s) for the auto generated code may be selected from options which include JAVA, C# and Objective-C.

In another embodiment of the present invention, the platform 10 further comprises an Application Programming Interface (API) allowing integration of the software application running on the platform 10 with an external software system through standard web communication protocols. The platform 10 provides an integration framework to deploy any combination of solutions that work together seamlessly and can also interact with other software systems through multiple Web API protocols (REST and SOAP for both JSON and XML formats).

In yet another embodiment the platform 10 further provides capability to add more features to an existing software application. A software application developed using the platform 10 may be edited later at any time to make changes and add or remove any features as per the needs of the user.

In another embodiment the platform 10 further provides capability to add more features to an external software application. Any external software application which was not built using the platform 10 may also be loaded on the platform 10, and new features may be added to the external software application by using components of the platform 10.

In another embodiment the platform 10 of the present invention, is adapted to be deployed on diverse infrastructure allowing implementation complimenting an external existing platform. The platform 10 can also compliment other platform implementation as it can be deployed on diverse infrastructures (including private network). This allows consumers to utilize core capabilities of their platform while leveraging the platform 10 of the present invention for simplification and rapid development and deployment of software applications.

In one embodiment of the present invention, the platform 10 is offered as a service for the development of the software application. The platform 10 is itself built as a core service framework.

In one embodiment of the present invention, the platform 10 is offered as a service for the deployment of the software application on the distributed computing environment 12 of the platform provider. A user can develop the software application and also host it on the platform 10.

In another embodiment of the present invention, the platform 10 offered as a software framework to be deployed on an external hosting environment. The platform 10 may be offered as a software framework to be deployed on a privately owned environment of the consumer or a third party hosting environment subscribed by the consumer such that software application, the platform and corresponding data is maintained in the consumer environment or the leased third party hosting environment.

In yet another embodiment of the present invention, the platform is offered as both a software framework and as a hosting environment service to maintain backup of software application and the corresponding data. The software application run on a user's computing device and when needed the user can store and synchronize the application data on the hosting environment of the platform 10. Similarly if there is any problem with his computing device which results in loss of data of the software application, the platform 10 may be used to retrieve the data from the hosting environment of the platform.

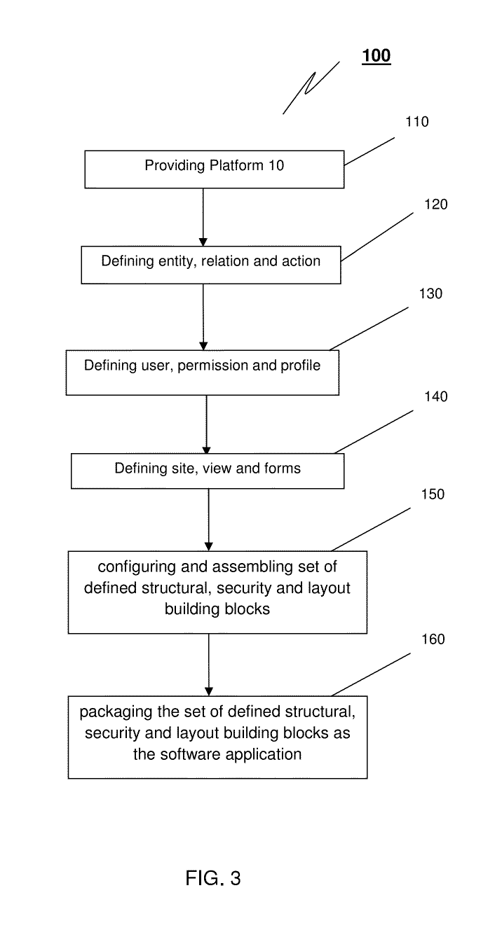

Referring to FIG. 3, which illustrates a flowchart of the method of developing a software application, according to one embodiment of the present invention. The method 100 starts with step 100 of providing the platform 10 for development of the software application of the present invention as described above. In next step 110 the entity, relation, action as required for the software application are defined for the structural building blocks 14. Now in next step 120 the user, user permission, profile as required for the software application is defined. Next the site, view, form as required for the software application is defined in step 130. At the end of this step set of defined structural, security and layout building blocks as per the software requirements are generated.

Now in next step 140 the configuring and assembling of the set of defined structural, security and layout building blocks is done. Now the set of defined structural, security and layout building blocks as the software application in step 150.

In one embodiment of the present invention, the step of configuring and assembling of the set of defined structural, security and layout building blocks auto generates a source code for the software application.

In another embodiment, the set of defined layout building blocks automatically generates the views and the forms which are adapted to work on a mobile computing device.

In yet another embodiment of the present invention a dedicated instance in the platform and the distributed computing environment are allocated for the software application. Such an instance of platform service is called a ‘domain’. And each of these domains can have different combination of solutions deployed and running on them to address specific consumer's needs. Each ‘domain’ along with respective data and customizations are kept isolated from each other. The isolation of these domains allows defining data structure specific to the domain. Such data structures are created by configuring entities and relations, further the operations that can be performed on these entities are defined by configuring actions.

The three primary components namely entities, relations and actions define what information can be stored and what actions can be performed within a software application. Such a application can then be exported from one domain and imported into another. Further a number of such applications can be assembled into one domain to provide a complete set of solutions for an organization.

In one embodiment an Application Programming Interface (API) is automatically generated allowing integration between different software applications running on the platform and an external software system through standard web communication protocols.

Performance, reliability, availability and scalability are built-in core characteristics of the platform itself, so the software application running on the platform inherit these characteristics and are focused on solving specific business problems.

Although the platform 10 of the present invention can serve for various software application development scenarios but it is primarily designed for three types of software projects, that are—
1) Migrating existing software to web and mobile platforms enabling a service oriented architecture.
2) Developing enterprise solutions as integrated business solutions running on the platform and interacting with other software systems.
3) Connecting digital devices (embedded systems and Programmable Logic Controllers (PLC) with cloud platform).

Other scenarios to which the platform 10 can be applied include developing working software/mobile app prototypes quickly, developing dynamic interactive websites that do not require server side programming or publishing media contents through standard protocols and specifications, etc.

Although a particular exemplary embodiment of the invention has been disclosed in detail for illustrative purposes, it will be recognized to those skilled in the art that variations or modifications of the disclosed invention, including the rearrangement in the steps of the method, changes in sequence, variations in steps may be possible. Accordingly, the invention is intended to embrace all such alternatives, modifications and variations as may fall within the spirit and scope of the claims of the present invention.

The exemplary embodiments described herein detail for illustrative purposes are subject to many variations of structure and design. It should be emphasized, however that the present invention is not limited to particular platform and method for development of a software application, as shown and described. Rather, the principles of the present invention can be used with a variety of configurations and arrangements of platform and method for developing software application. It is understood that various omissions, substitutions of equivalents are contemplated as circumstances may suggest or render expedient, but the present invention is intended to cover the application or implementation without departing from the spirit or scope of the claims.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

What is claimed is:

1. A platform for development of a software application, comprising:
a distributed computing environment including a plurality of server computers with a software providing storage and hosting capabilities;
a set of structural building blocks including a entity, a relation, a action for defining data structures of the software application;
a set of security building blocks including a user, a user permission, a profile for defining security settings for the software application;
a set of layout building blocks including a site, a view, a form for defining a user interface design for the software application; and
a module to configure and assemble the sets of the structural, the security and the layout building blocks as the software application.

2. The platform according to claim 1, wherein the software application is deployed to run in the platform using the distributed computing environment.

3. The platform according to claim 1, wherein the software application is downloaded from the platform to be deployed on a computing device.

4. The platform according to claim 3, wherein the software application deployed on the computing device interacts with the platform to use the distributed computing environment.

5. The platform according to claim 1, wherein the module to configure and assemble automatically writes a required source code for the software application.

6. The platform according to claim 1, wherein the module to configure and assemble automatically writes a required source code for running the software application on a mobile computing device.

7. The platform according to claim 1, further comprising a Application Programming Interface (API) allowing integration of the software application running on the platform with an external software system through standard web communication protocols.

8. The platform according to claim 1, wherein the platform further provides capability to add more features to an existing software application.

9. The platform according to claim 1, wherein the platform further provides capability to add more features to an external software application.

10. The platform according to claim 1, wherein the platform is adapted to be deployed on diverse infrastructure allowing implementation complimenting an external existing platform.

11. The platform according to claim 1, wherein the platform is offered as a service for the development of the software application.

12. The platform according to claim 1, wherein the platform is offered as a software framework to be deployed on an external hosting environment.

13. A method of developing a software application, comprising steps of:
providing a platform for development of the software application, comprising:
a distributed computing environment including a plurality of server computers with a software providing storage and hosting capabilities;
a set of structural building blocks including a entity, a relation, a action for defining data structures of the software application;
a set of security building blocks including a user, a user permission, a profile for defining security settings for the software application;
a set of layout building blocks including a site, a view, a form for defining a user interface design for the software application; and
a module to configure and assemble the sets of the structural, the security and the layout building blocks as the software application;
defining the entity, the relation, the action as required for the software application;
defining the user, the user permission, the profile as required for the software application;
defining the site, the view, the form as required for the software application;
configuring and assembling a set of defined structural, security and layout building blocks as per requirements;
packaging the set of defined structural, security and layout building blocks as the software application.

14. The method according to claim 13, wherein the configuring and assembling of the set of defined structural, security and layout building blocks auto generates a source code for the software application.

15. The method according to claim 13, wherein the set of defined layout building blocks automatically generates the views and the forms which are adapted to work on a mobile computing device.

16. The method according to claim 13, wherein a dedicated instance in the platform and the distributed computing environment are allocated for the software application.

17. The method according to claim 13, wherein the action includes one from a list of create, read, update, delete, import, export records, upload or download attachments or a combination thereof.

18. The method according to claim 13, wherein an Application Programming Interface (API) is automatically generated allowing integration between different software applications running on the platform and an external software system through standard web communication protocols.
